(19) United States
(12) Patent Application Publication
(10) Pub. No.: US 2016/0128276 A1
(43) Pub. Date: May 12, 2016

(54) LINE-WINDING SPOOL FOR GRASS-CUTTING HEADS

(71) Applicant: ARNETOLI MOTOR S.R.L., Reggello (IT)

(72) Inventor: Fabrizio ARNETOLI, Reggello (IT)

(21) Appl. No.: 14/937,043

(22) Filed: Nov. 10, 2015

(30) Foreign Application Priority Data
Nov. 11, 2014 (IT) FI2014A000252

(51) Int. Cl. A01D 34/416

(52) U.S. Cl. CPC A01D 34/4166

(57) ABSTRACT

Line-winding spool for grass-cutting heads, comprising a central body provided with a central axis of rotation coinciding with the axis of rotation of the grass-cutting head when inserted into it, said central body having a circumferential side area on which there is defined the annular area where the cutting line is wound, said spool having at least one channel crossing said central body transversally, provided with two openings on opposite portions of said side area for the insertion of the cutting line, said at least one channel having two opposite first segments starting from said openings towards the inside of the central body, and a curved connection segment between said first segments having a concave shape with the concavity upwards, said central body defining, in said concavity, a cavity, whose bottom is at a lower axial height than the axial height of said openings, characterized in that said curved connection segment has a lower surface that is substantially continuous along all its extension so as to be substantially closed downwards, with respect to the outer environment, to allow a single passage of the line from a said opening towards the opposite opening without the line exiting from said central body.

### TECHNICAL FIELD

The present invention relates to the field of grass-cutting heads, and especially of grass-cutting heads wherein a cutting line is wound around a line-winding spool housed in an outer housing of the head. In detail, the object of the invention is a spool for grass-cutting heads and a grass-cutting head provided with said spool.

### STATE OF THE ART

As it is well known, in the field of gardening equipment, at both amateur and professional level, grass-cutting heads are commonly used, having, as cutting element, a plastic line. These heads are provided with a spool, around which a stock of cutting line is wound. The spool is housed in a housing, provided with holes for the passage of the cutting line towards the outside. Ends of the cutting line projecting towards the outside of the housing are used as cutting members, rotating the head at high speed around its axis of rotation.

In use, the cutting line wears or breaks; new line is thus unwound from the spool by means of adequate spring devices, with which the cutting head is provided, and is made project from the head.

In use, the head is fastened to the end of a drive shaft of a brush cutter provided with an electric motor or an internal combustion engine. The head is mechanically coupled to the drive shaft by means of a mechanical coupling insert. The length of this mechanical coupling insert depends on the head type and the drive shaft type employed. In some cases, the mechanical coupling insert may extend coaxially with the spool inside a spool axial cavity.

To “replace” the line around the spool, i.e. to wind a given length of line around the spool and form a line stock that is then gradually unwound during use as the cutting line wears or breaks, it is usually necessary to open the head, to remove the spool and to fix the cutting line(s) thereto. The line(s) is then wound around the spool central body, leaving the line ends free. These ends are passed from the inside through the line passage bushes provided on the wall of the head housing, and then the housing, with the spool and the line wound around it, is closed.

These operations are particularly complex and time-consuming. Systems have been therefore developed, allowing to replace the file in the head—winding it around the spool—without the need for opening the head. Solutions are for example known, according to which, to replace the line, the line is inserted transversally to the spool, by simply aligning the holes of the spool housing with openings of pairs of transverse channels allowing the line to enter the spool through a first channel, to exit from the lower base thereof and to enter again the same base towards the inside of a second channel and to exit on the opposite side of the spool and of the housing. This kind of solutions are described for instance in the patent documents associated with EP2099280.

These solutions are particularly complex from a construction viewpoint and, moreover, they are structured so that dirt may enter from the spool lower base, that is open to allow the line passage, thus causing friction and blocking the line sliding during the “automatic” replacement of the line from the spool when necessary.

There is therefore the need for a grass-cutting head that allows a simpler and more efficient replacement of the cutting line, without opening the head housing and without the need for removing the spool from the housing, and that prevents dirt from entering the spool and limiting the operation thereof.

### SUMMARY OF THE INVENTION

Embodiments of the invention described herein provide for a line-winding spool for grass-cutting heads comprising a central body provided with a central axis of rotation coinciding with the axis of rotation of the grass-cutting head when inserted into it, this central body having a circumferential side area on which there is defined the annular area where the cutting line is wound; the spool has at least one channel crossing the central body transversally and provided with two openings on opposite portions of the side area for the insertion of the cutting line; this channel has two opposite first segments starting from said openings towards the inside of the central body, and a curved connection segment between said first segments, having a concave shape with the concavity upwards; the central body defines, in said concavity, a cavity, whose bottom is at a lower axial height than the axial height of the openings. The spool is characterized in that the curved connection segment comprises a lower surface that is substantially continuous along all its extension so as to be substantially closed downwards, with respect to the outer environment, to allow a single passage of the line from an opening towards the opposite opening without the line exiting from the central body.

In this description, the terms “high”, “low”, “upper”, “lower”, etcetera, refer to a spool arranged in the grass-cutting head with the axis of rotation positioned vertically, in a typical configuration of use.

The term “substantially closed downwards” means that the line, when inserted in the channel, slides through the channel exiting only from the opposite opening with respect to the entrance opening, and that the channel cannot be accessed from the bottom to manipulate the line. Therefore, on this channel small holes or slots downwards may be even provided, for example to allow water outflow when the spool is still or for other purpose, that however do not allow a user to interact with the cutting line.

### BRIEF DESCRIPTION OF THE DRAWINGS

Further characteristics and advantages of the invention will be more apparent from the description of seven preferred, although not exclusive, embodiments, illustrated by way of non-limiting example in the attached tables of drawings, wherein:

FIG. 1A illustrates a plan view of a first embodiment of a spool according to the invention, wherein a cutting line is inserted defining two cutting segments projecting laterally; the same figure shows a plan view of a second, a fourth and a fifth embodiment of a spool according to the invention, listed below;

FIG. 1B is a cross-section view according to the line A-A of FIG. 1A of the first embodiment of the spool according to the invention, indicating the cross-section of a head housing the spool;

FIG. 1C is an exploded axonometric view of the spool of FIG. 1B;

FIG. 1D shows the same view of FIG. 1B cut from the plane A-A indicated in FIG. 1A;

FIG. 2A is an exploded axonometric view of a second embodiment of a spool according to the present invention;

FIG. 2B shows the same view of FIG. 2A cut from the plane B-B indicated in FIG. 1A;

FIG. 2C shows the same view of FIG. 2A cut from the plane A-A indicated in FIG. 1A;

FIG. 2D is a cross-section according to the line A-A of FIG. 1A of the spool of FIG. 2A;

FIG. 3A is a plan view of a third embodiment of a spool according to the invention, wherein a cutting line is inserted defining two cutting segments projecting laterally;

FIG. 3B is an axonometric view of the spool of FIG. 3A cut by the plane A-A of FIG. 3A;

FIG. 3C is an axonometric exploded view of the spool of FIG. 3A without cutting line, cut by the same plane;

FIG. 3D is an axonometric exploded view of the spool of FIG. 3A without cutting line, cut by the plane B-B of FIG. 3A;

FIG. 4A is an exploded axonometric view of a fourth embodiment of a spool according to the present invention;

FIG. 4B is an axonometric view of the spool of FIG. 4A cut by the plane A-A of FIG. 1A;

FIG. 4C is a cross-section according to the line A-A of FIG. 1A of the spool of FIG. 4A;

FIG. 5A is an exploded axonometric view of a fifth embodiment of a spool according to the present invention;

FIG. 5B is an axonometric view of the spool of FIG. 5A cut by the plane A-A of FIG. 1A;

FIG. 5C is a cross-section according to the line A-A of FIG. 1A of the spool of FIG. 5A;

FIG. 6A illustrates a plan view of a sixth embodiment of a spool according to the invention, wherein a cutting line is inserted defining two cutting segments projecting laterally; the same figure shows a plan view of a seventh embodiment of a spool according to the invention, detailed below;

FIG. 6B is an axonometric view of the spool of FIG. 6A cut by the plane A-A of FIG. 3A;

FIG. 6C is an axonometric exploded view of the spool of FIG. 6A without cutting line, cut by the same plane;

FIG. 7A is an exploded axonometric view of a fourth embodiment of a spool according to the present invention;

FIG. 7B is an axonometric view of the spool of FIG. 7A cut by the plane A-A of FIG. 6A.

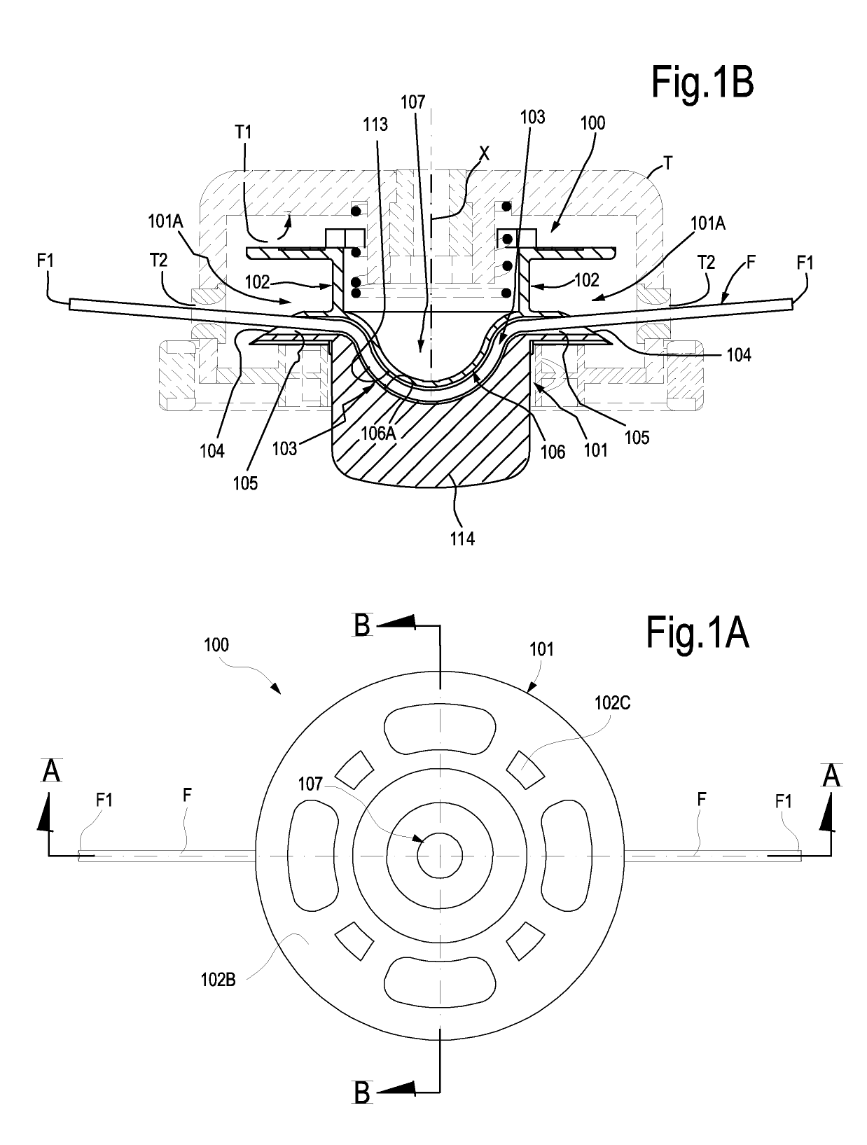

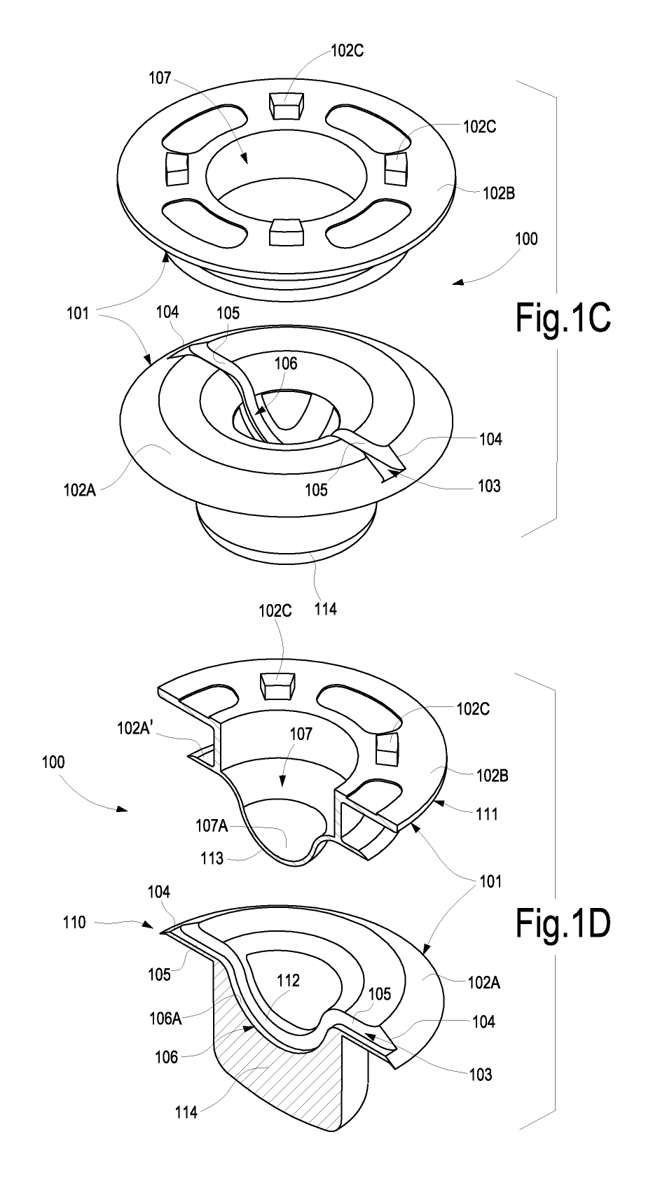

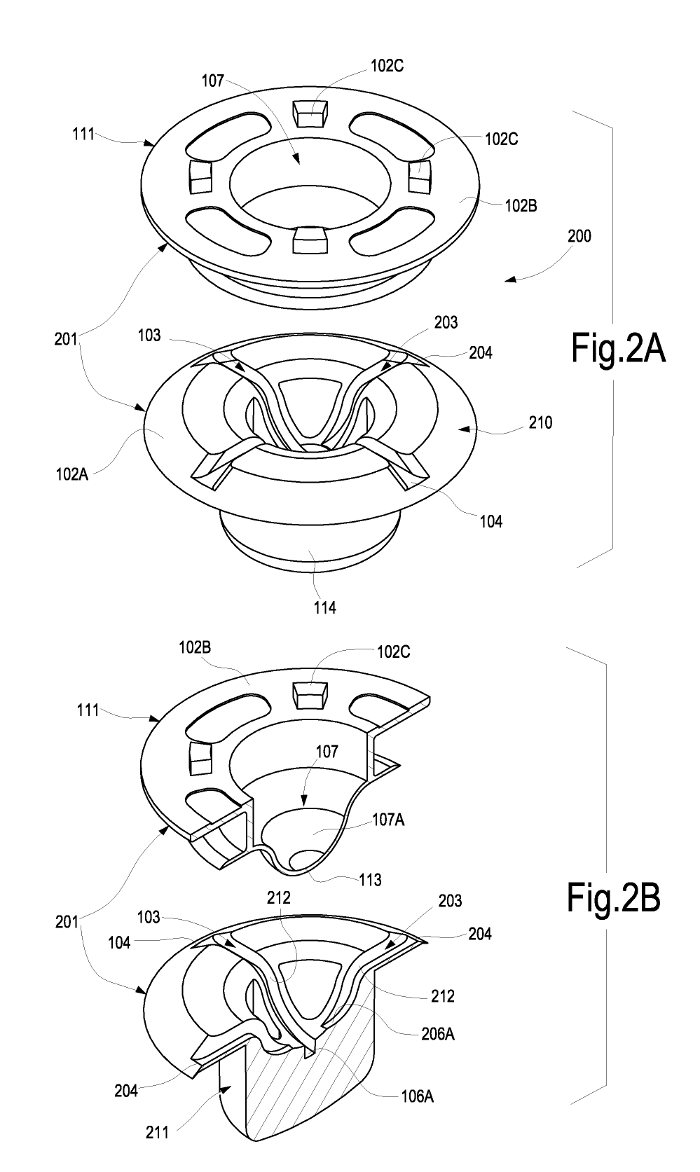

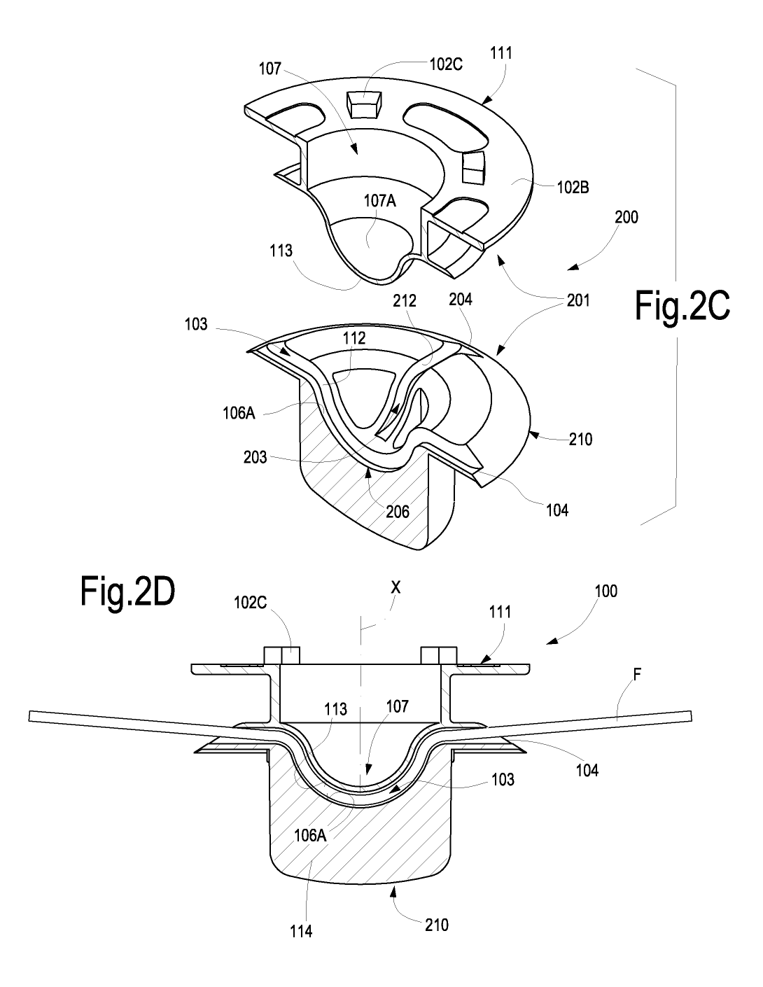

The six embodiments of spool illustrated in FIGS. 2 to 7, alternative to the embodiment of FIG. 1, may be housed in the head of FIG. 1B. Herein, they shall be considered, therefore, as housed in the head of FIG. 1.

### DETAILED DESCRIPTION OF AN EMBODIMENT OF THE INVENTION

With reference to FIGS. 1A-1C cited above, a first embodiment of a line-winding spool for grass-cutting heads according to the invention is indicated as a whole with number 100.

The spool 100 comprises a central body 101 provided with a central axis of rotation X coinciding with the axis of rotation of the grass-cutting head T (schematized in FIG. 1B with a dotted line) when inserted in it.

The central body 101 has a circumferential side area 101A on which there is defined the annular area 102 where the cutting line F is wound. In all the examples of the present description, the cutting line accumulated in the annular area 102 is not shown, but it should be understood that it is included in this area and that the ends F1 and F2 of the line represent the ends of the line collected in the annular area 102. Obviously, in other embodiments the spool according to the invention may be also used with only a simple line segment inserted in the spool, without accumulation in the area 102.

In these examples, two flanges are provided, i.e. a lower flange 102A defining the lower limit of the annular area 102 where the cutting line F is wound, and an upper flange 102B defining the upper limit of the annular area. On the upper face of the upper flange 102B teeth 102C are provided for the connection, according to the axial position of the spool in the housing T1 inside the head T, to the line replacement mechanism associated with the head T, for instance of a known type.

The spool 100 has a channel 103 crossing the central body 101 transversally and provided with two openings 104 on opposite portions of the side area 101A for the insertion of the cutting line. In this example, as well as in other embodiments, the openings 104 are provided on the lower flange 102A.

The channel 103 has two opposite first segments 105 starting from the openings 104 towards the inside of the central body 101, and a curved connection segment 106 between the first segments 105.

The curved connection segment 106 has a concave shape with the concavity upwards. Practically, the central body 101 defines, in this concavity, a cavity 107, whose bottom 107A is at a lower axial height than the axial height of the openings 104.

In the described examples, the axis of extension of the transverse channel 103 lies substantially on the same plane where the central axis X of the central body 101 lies, practically a radial plane. In FIG. 1B this plane corresponds to the section plane. The firsts segments 105 are preferably orthogonal to the axis X. Obviously, in other embodiments the channel may extend not on a plane but on a curved surface or, for some segments, on different planes.

According to the invention, the curved connection segment 106 has a lower surface 106A that is substantially continuous along all its extension. Practically, the curved segment 106 is substantially closed downwards, with respect to the outer environment, and the line F, when inserted in an opening 104 and pushed inside the channel, travels along the first first segment 105, all the connection segment 106 and the last first segment 105, and exits from the opposite opening 104 without exiting from any other opening, hole or slot, i.e. without the need for intermediate manipulation between the passage from an opening 104 to the other, to allow a single passage of the line between the openings.

The structure described above is substantially common to all the examples described below.

In this example, the central body 101 is comprised of two elements, each of which is provided in a single piece, integrally coupled together during the spool construction phase by means of a specific fixing device, according to the production needs and/or the material of which the elements are made.

In particular, a first lower element 110 is provided, on which the continuous lower surface 106A is defined of the curved connection segment 106 of the channel 103, and a second upper element 111 arranged above the first lower element 110 and defining the upper surface of said curved connection segment. More in particular, in this example, all the bottom and all the flanks 112 of the channel 103 are provided on the first lower element, while all the top 113 of the channel 103 is constituted by the second upper element (practically constituted by the bottom of the cavity 107 defined on this second element 111). In this example, the second upper element 102 has a small portion 102A′ of the lower flange 102A acting as a ceiling for the first segments 105 of the channel 103.

In this example, the first lower element 110 has a central lower knob 114 (for example with known functionalities), a sort of protuberance extending downwards from the lower flange 102A, coaxially with the axis X, and whose width is lower than the maximum width of the central body 101. Practically, in this example, on the upper portion of this knob 114 the lower continuous surface 106A is defined of the curved connection segment 106 of the channel 103. In this example, the knob 114 is made in a single piece with the first lower element 110.

The function of this knob is, for example, to act as an abutment surface to move the spool axially with respect to the housing T1 of the head T and to allow the steps of coupling to/releasing from the line replacement mechanisms and/or the drive shaft of the bush cutter, with which the head is associated. Moreover, the knob 114 acts as a gripping area for the user's hand to align the openings 104 of the spool 100 with the side holes T2 of the housing of the head T, in order to allow the insertion of the line into the spool.

The fixing device for fixing the two elements 110 and 111 may comprise one or more of the following: welding, one or more adhesive matter (adhesives, glues, etc.), coupling or snap-coupling or mechanical joining of complementary parts (for instance snap-fit coupling, friction coupling by means of elastically yielding members, constraining teeth etcetera), or joining by means of threaded members. The welding is preferably ultrasonic, thermal or chemical welding.

In this embodiment, the first and the second element 110 and 111 are made of plastic and are preferably joined by means of a fixing device comprising an ultrasonic welding, but also other types of fixing devices may be used.

FIGS. 2A to 2D show a second embodiment of spool, different from the first embodiment in that it has two channels for the cutting line. In the description below, reference numbers equal to those used in the previous example will be used for substantially equal or equivalent parts, while new reference numbers will be used for new or changed parts.

In this example the spool, indicated with 200, has a central body 201 comprised of two elements, namely a first lower element 210 and a second upper element 111. Practically, the spool differs from that of the previous example in that the lower portions of two channels 103 and 203 for the line F, directed preferably orthogonal to each other, are provided on the first lower element 210. These lower portions provide for both the lower surfaces of the respective channels (and therefore also the lower surfaces 106A and 206A of the curved segments), and the respective flanks 112, 212. The two channels 103 and 203 intersect/overlap each other in the area of the axis X. Therefore, two pairs of opposite openings of the channels are provided, i.e. openings 104 and 204 respectively. In this example, the function of the two channels, having double openings, is to have a double choice for the insertion of the line during the replacement thereof, thus facilitating this step. The cutting ends exiting from the head T are two.

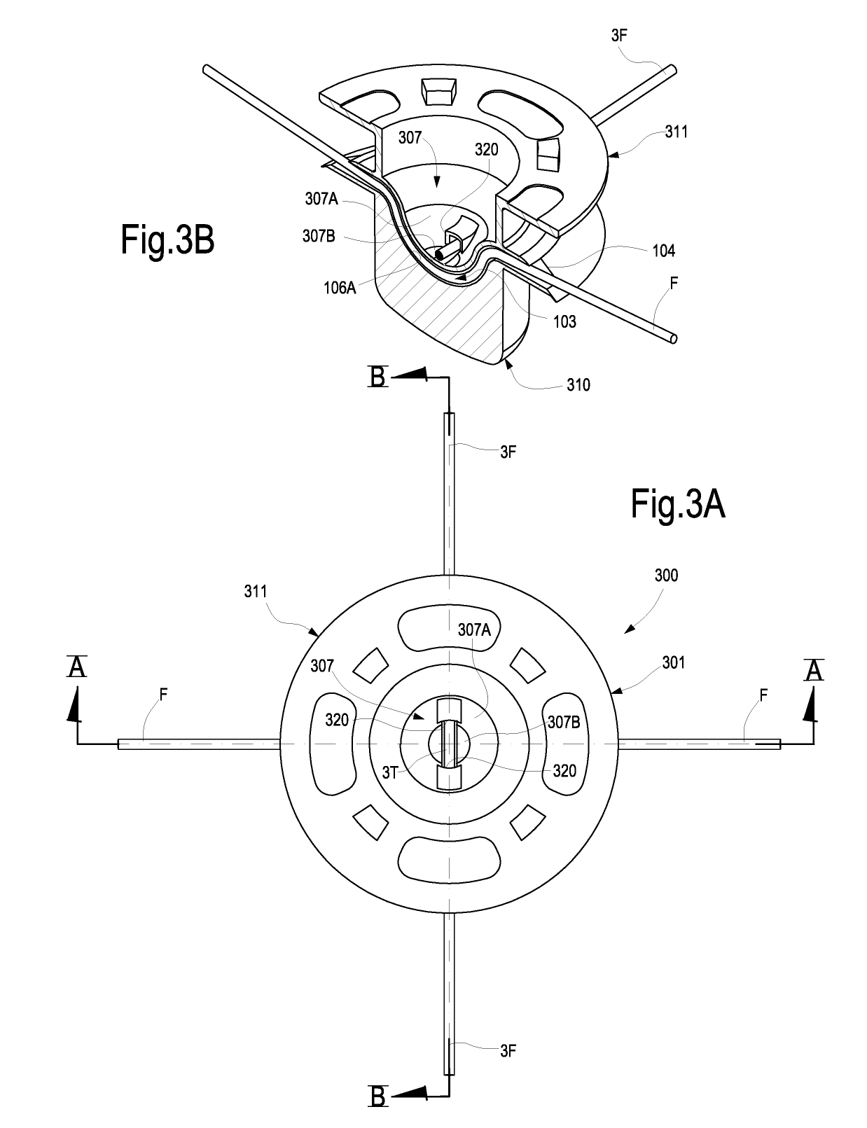

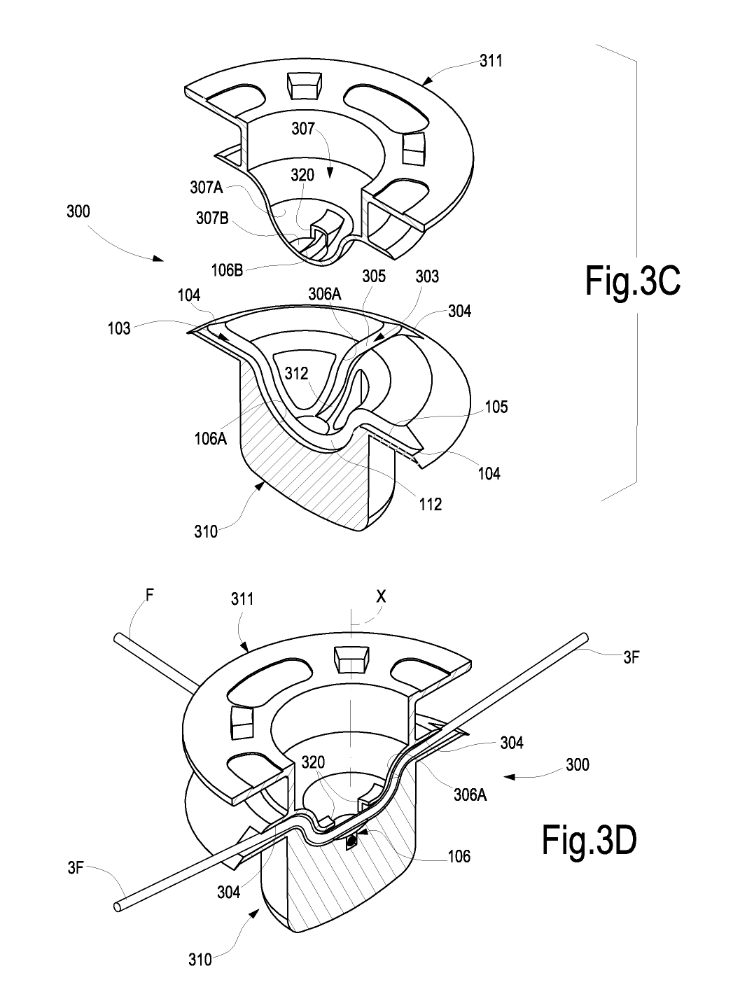

In FIGS. 3A to 3D, a third embodiment of the spool is shown, different from the second embodiment in that it is suitable to take two cutting lines contemporaneously, i.e. it has, externally, four cutting ends contemporaneously. The difference with respect to the previous embodiment is in the configuration of the intersection/overlapping area of the two cutting lines in the area of the axis X. In the description below, reference numbers equal to those used in the first example will be used for substantially equal or equivalent parts, while new reference numbers will be used for new or changed parts.

In this example the spool, indicated with 300, has a central body 301 comprised of two elements, namely a first lower element 310 and a second upper element 311. Practically, the spool differs from that of the previous example in that the lower portions of two channels 103 and 303 for two lines F and 3F, directed preferably orthogonal to each other, are provided on the first lower element 310. These lower portions provide for both the lower surfaces 106A and 306A of the curved segments 106 and 306 together with the lower portions of the first segments 105, 305, and the respective flanks 112 and 312. Two pairs of opposite openings of the channels are provided, i.e. openings 104 and 304 respectively. The two channels 103 and 303 overlap each other in the area of the axis X, without intersecting each other. More in particular, in this example the second upper element 311, in correspondence of the bottom 307A of the cavity 307, has a lower portion 307B defining the ceiling of the curved connection segment 106 of a first channel 103. At the side of this lower portion 307B, two opposite holes 320 are provided, passing through the bottom of the cavity 307 an d suitable to put in communication opposite parts of the lower portion of channel 303; practically, part of the curved connection segment 306 is defined on the bottom of the cavity 307 and is separated from, and overlapped by, the curved connection segment 106 of the other channel 103 by means of the lower portion 307B of the bottom of the cavity 307.

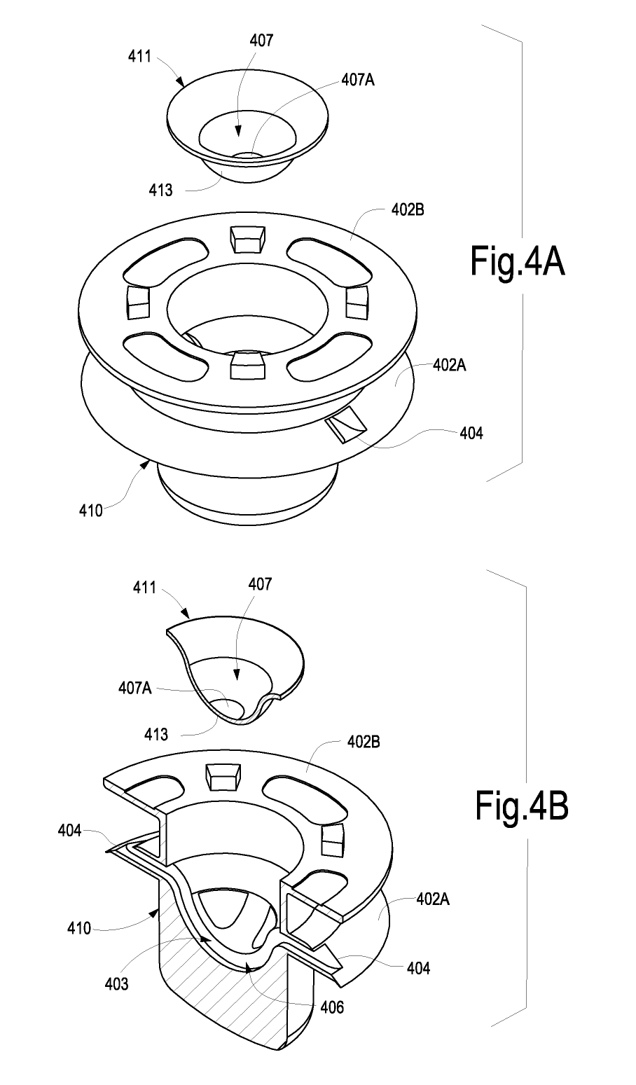

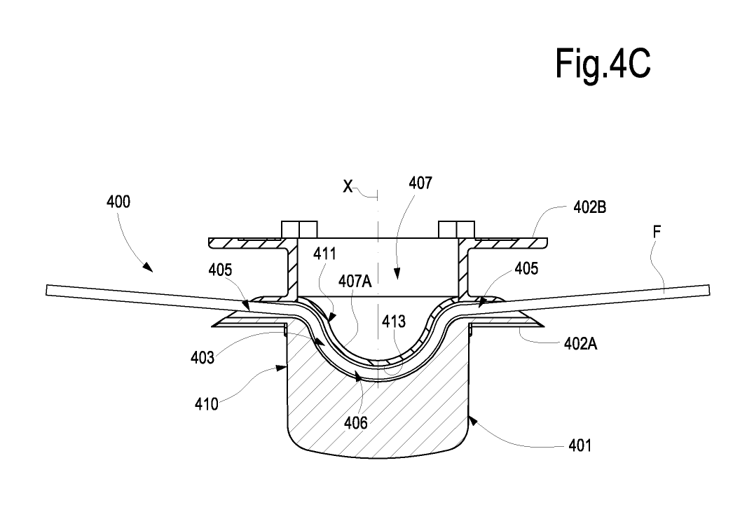

FIGS. 4A to 4C show a fourth embodiment of the spool 400 according to the invention, differing from the first embodiment in some aspects. In the description below, reference numbers equal to those used in the previous example will be used for substantially equal or equivalent parts, while new reference numbers will be used for new or changed parts.

In particular, the difference is that the upper flange 402B is integral with the first lower element 410, while the second element 411 has only the function to define the ceiling 413 of the curved connection segment 406. More in particular, the conformation of the central body 401 is substantially and functionally equal to that of the central body 101 of the first embodiment, except for the fact that, in this embodiment, the bottom 107A of the cavity 107 of the spool 100 of the first embodiment is separate. Practically, this cavity, indicated with 407 and whose bottom is indicated with 407A, represents the second element 411, that, during the spool construction, is fixed to the first lower element 410 inside the space 430 of this first element 410 overlapped to the channel 403, for instance by means of ultrasonic welding (but also other fixing means may be used, for instance snap-fit coupling of the second element 411 in the space 430). The first segments 405 of the channel 403 are completely provided in the first lower element 410.

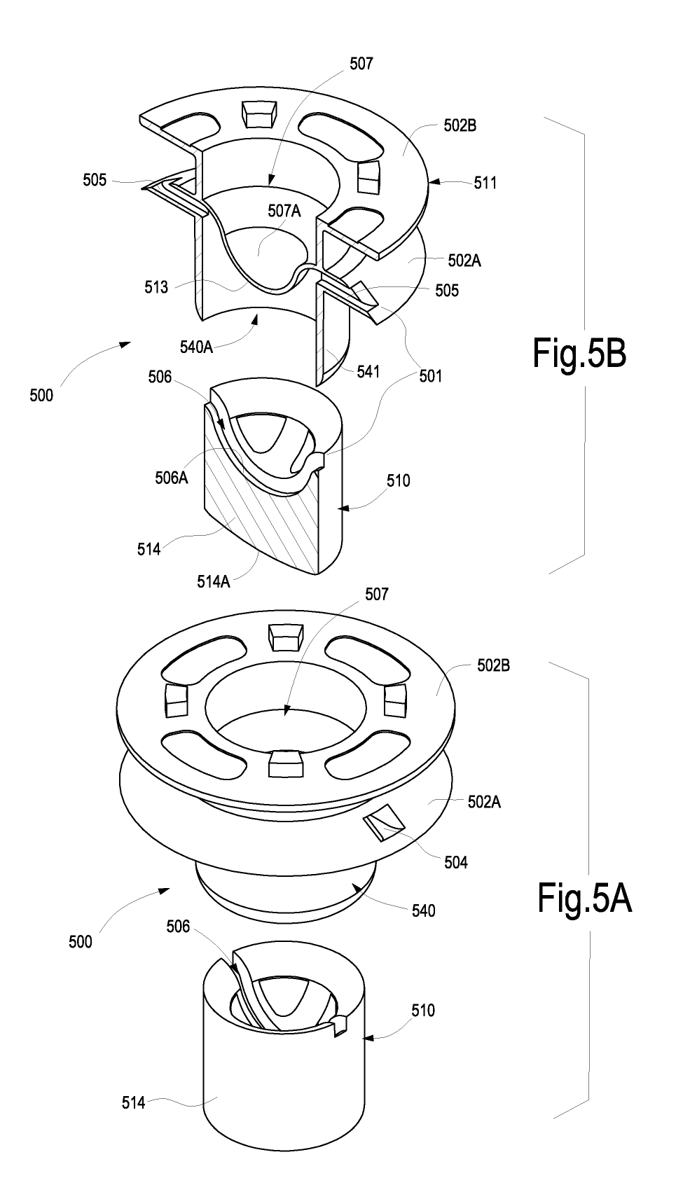

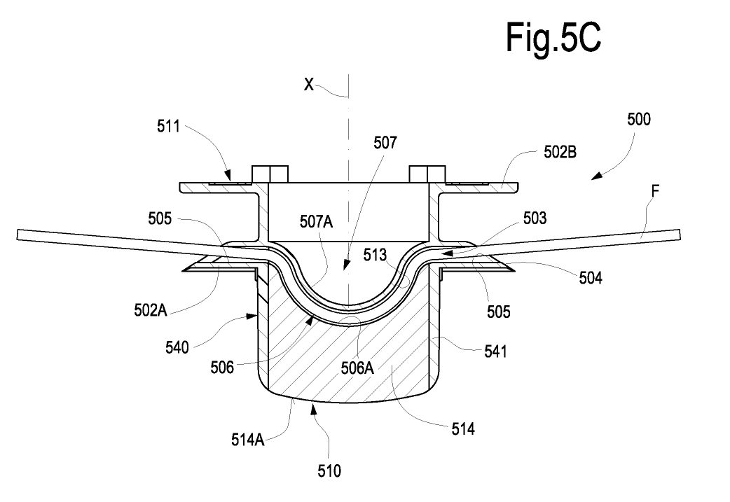

FIGS. 5A to 5C show a fifth embodiment of a spool 500 according to the invention, differing from the first embodiment in some aspects. In the description below, reference numbers equal to those used in the previous example will be used for substantially equal or equivalent parts, while new reference numbers will be used for new or changed parts.

Unlike the first spool 100, in this embodiment the first lower element 510 is without the lower flange 502A. Therefore, the second upper element 511 has both the flanges.

More in particular, in this example the first lower element 510 has the upper end defining only the continuous surface 506A of the curved connection segment 506 of the channel 503, while the first segments 505 are completely defined in the second upper element 511. Both the bottom 507A of the cavity 507 and the opposite ceiling 513 of the curved connection segment 506 are defined on the second upper element.

More in particular, in this example the first lower element 510 is substantially constituted by the knob 514. More in particular, the knob 514, i.e. the first lower element 510, is inserted and welded, for instance by means of ultrasonic welding, inside the space 540 A of a sleeve 540 projecting from the second upper element 511 downwards coaxially with the axis X, wherein the ceiling of this sleeve is the ceiling 513 of the curved connection segment 506. i.e. the opposite face of the bottom 507A of the cavity 507. The walls 541 of the sleeve 540 end at the lower end of the base 514A of the knob 514, that is preferably convex. Besides ultrasonic welding, also other fixing means may be used, for instance a snap-fit coupling in the inner space of the sleeve 540.

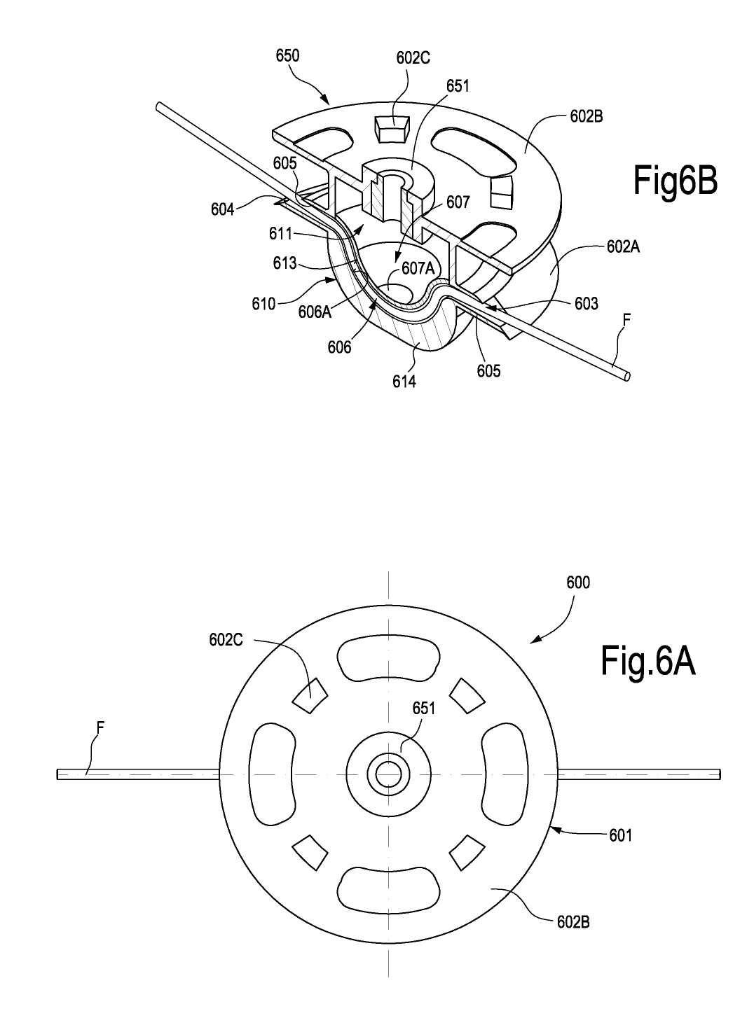

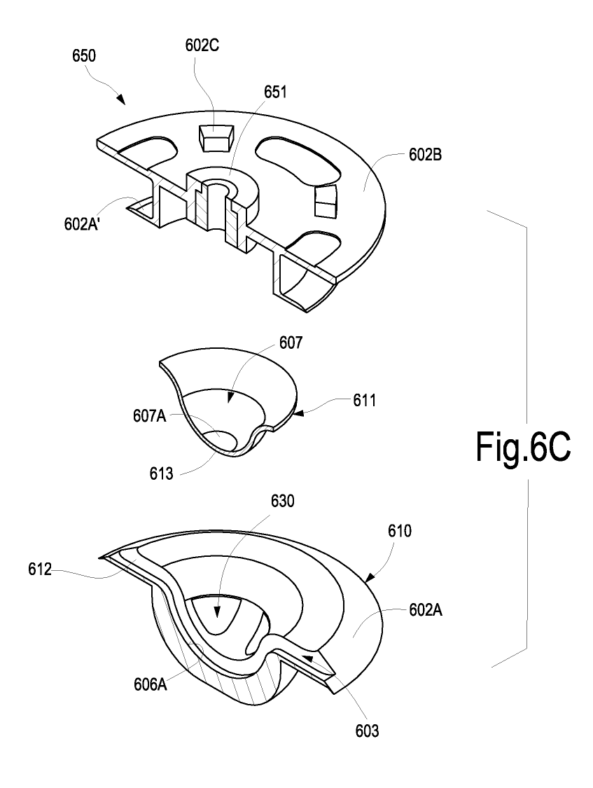

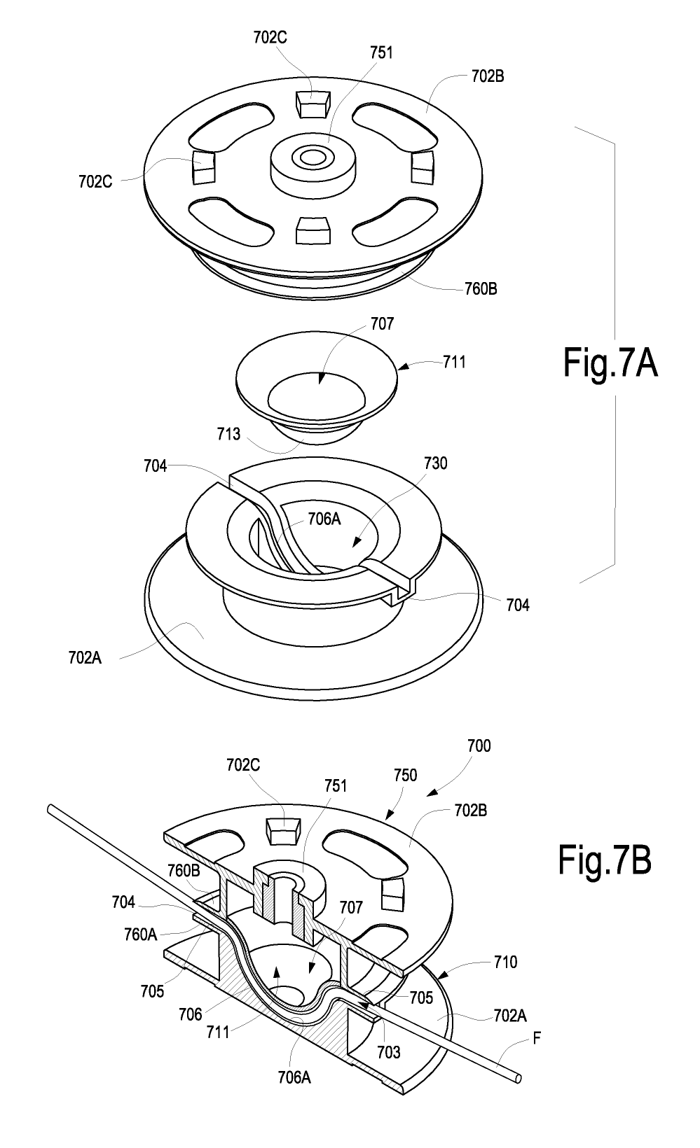

FIGS. 6A-6C and 7A-7B represent two embodiments of spool according to the invention, of the “drawing” type known in se, wherein the central body is constituted by three elements fixed together in integral and preferably not releasable fashion.

In particular, FIGS. 6A to 6C show a sixth embodiment of a spool 600 according to the invention, differing from the first embodiment in some aspects. In the description below, reference numbers equal to those used in the previous example will be used for substantially equal or equivalent parts, while new reference numbers will be used for new or changed parts.

The central body 601 comprises a first lower element 610, similar to that shown in the first embodiment, and therefore comprises the knob 614 (less projecting than in the previous example) and the lower flange 602A. The lower continuous surface 606A of the curved connection segment 606 is defined on the upper end of the knob 614, while the lower surfaces of the first segments 605 of the channel 603 and the flanks 612 are provided on the lower flange.

In this embodiments, like in the fourth one, a second element 611 is provided, whose only function is to define the ceiling 613 of the curved connection segment 606. More in particular, the conformation of the central body 601 is functionally equal to that of the central body 101 of the first embodiment, except for the fact that in this embodiment the bottom 107A of the cavity 107 of the spool 100 is separate. Practically, this cavity, indicated with 607 and whose bottom is indicated with 607A, represents the second element 611, that, during the spool construction, is fixed to the first lower element 610 inside the space 630 of this first element 610, overlapped to the channel 603, for instance by means of ultrasonic welding (but also other fixing means may be used, for instance snap-fit coupling of the second element 611 in the space 630).

A third element 650 is provided with the upper flange 602B with teeth 602C and has, in the center of the flange, a bushing 651 to fix the head to the drive shaft of a bush cutter.

This element 650 has, at the bottom and at the side, a small portion 602A′ of the lower flange 102A acting as at ceiling op for the first segments 605 of the channel 603.

The three elements 610, 611 and 650 are fixed together, for example by means of ultrasonic welding (but also other types of fixing may be used).

FIGS. 7A and 7B show a sixth embodiment of a spool 700 according to the invention, differing from the first embodiment in some aspects. In the description below, reference numbers equal to those used in the previous example will be used for substantially equal or equivalent parts, while new reference numbers will be used for new or changed parts.

In particular, the central body 701 of this example differs from the central body 601 of the previous example in that there is no the lower knob on the first lower element 710 and that the lower face of this latter is constituted by the lower flange 702A. Analogously, the upper face of the central body 701 is defined by the upper flange 702B of the third element 750, as in the previous example.

The openings 704 of the channel 703 and the respective first segments 705 are defined in an axial intermediate position between said two flanges, in an intermediate flange formed by two rings 760A and 760B, defined on the first lower element 710 and on the third upper element 750 respectively. In this case again, the only function of the second element 611 is to define the ceiling 613 of the curved connection segment 606 and the cavity 607.

The three elements 710, 711 and 750 are fixed together, for example by means of ultrasonic welding (but also other types of fixing may be used).

It is understood that what illustrated above purely represents possible non-limiting embodiments of the invention, which may vary in forms and arrangements without departing from the scope of the concept on which the invention is based. One or more feature of an embodiment may be combined with features of other embodiments without departing from the protective scope of the invention. Any reference numbers in the appended claims are provided for the sole purpose of facilitating the reading thereof in the light of the description before and the accompanying drawings and do not in any way limit the scope of protection of the present invention.

1. A line-winding spool for a grass-cutting head provided with an axis of rotation, the line-winding spool comprising:
a central body comprising a central axis of rotation coinciding with the axis of rotation of the grass-cutting head when inserted into the grass-cutting head, a circumferential side area and an annular area where a vegetation cutting line is wound, said annular area where the vegetation cutting line is wound being defined on said circumferential side area, said circumferential side area comprising opposite portions; and
at least one channel crossing said central body transversally, said at least one channel comprising two openings on said opposite portions of said circumferential side area for insertion of the vegetation cutting line, said at least one channel comprising two opposite first segments starting from said two openings towards an inside of the central body, and a curved connection segment between said first segments having a concave shape with a concavity upwards, said central body defining, in said concavity, a cavity comprising a bottom, said bottom being at a lower axial height than an axial height of said two openings, wherein said curved connection segment comprises a lower surface that is substantially continuous all along an extension thereof so as to be substantially closed downwards, with respect to an outer environment, to allow a single passage of the vegetation cutting line from one of said two openings towards another one of said two openings without the vegetation cutting line exiting from said central body, said one of said two openings being opposite said another one of said two openings.

2. A spool according to claim 1, wherein said central body comprises at least two elements, integrally coupled during a spool construction phase by means of a fixing device, said at least two elements comprising a first lower element, on which is defined the lower surface of said curved connection segment, and a second element arranged above at least part of said first lower element, defining an upper surface of said curved connection segment.

3. A spool according to claim 2, wherein said bottom of said cavity is defined on said second element.

4. A spool according to claim 2, further comprising a lower flange defining a lower limit of said annular area where said vegetation cutting line is wound.

5. A spool according to claim 4, further comprising a further flange arranged above said lower flange and defining an upper limit of said annular area where said vegetation cutting line is wound.

6. A spool according to claim 4, wherein said lower flange is defined on said first lower element.

7. A spool according to claim 5, wherein said further flange is defined on said second element.

8. A spool according to claim 5, wherein said lower flange and said further flange are defined on said first lower element.

9. A spool according to claim 5, wherein said lower flange and said further flange are defined on said second element.

10. A spool according to claim 4, wherein said central body further comprises at least one further third element, integrally and irreversibly coupled to said first element and said second element during the spool construction phase, said upper flange being arranged on said third element.

11. A spool according to claim 2, wherein said at least one channel has said lower surface of said curved connection segment and flanks thereof defined on said first lower element.

12. A spool according to claim 2, wherein said central body comprises a lower central knob, said lower central knob having a width that is less than a maximum width of said central body, projecting downwards, said lower surface of said curved connection segment being defined on an upper portion of said lower central knob, said central body comprising an element distinct from said central knob, said lower surface of said curved connection segment being closed at a top by said element distinct from said central knob to define said curved connection segment.

13. A spool according to claim 12, wherein said central knob is made in a single piece with said first lower element.

14. A spool according to claim 4, wherein said two openings are defined on said lower flange.

15. A spool according to claim 5, wherein said two openings are defined in an axial intermediate position between said lower flange and said further flange.

16. A spool according to claim 1, further comprising another channel to provide at least two channels crossing said central body transversally, each of said two channels respectively being provided with said two openings on said opposite portions of said circumferential side area, said at least two channels intersecting with each other or being one above another in a central area of said central body.

17. A spool according to claim 1, wherein said at least one channel comprises an axis of extension, said axis of extension of said at least one channel lying substantially on a same plane where the central axis of said central body lies.

18. A spool according to claim 2, wherein said fixing device for fixing said at least two elements comprises one or more of welding, adhesive matter, coupling of complementary parts, snap-coupling of complementary parts, mechanical joining of complementary parts and joining by means of threaded members.

19. A spool according to claim 18, wherein said welding is ultrasonic, thermal or chemical.

20. A grass-cutting head comprising:
a housing for a spool, said spool comprising a central body comprising a central axis of rotation coinciding with the axis of rotation of the grass-cutting head when inserted into the grass-cutting head, a circumferential side area and an annular area where a vegetation cutting line is wound, said annular area where the vegetation cutting line is wound being defined on said circumferential side area, said circumferential side area comprising opposite portions, said spool further comprising at least one channel crossing said central body transversally, said at least one channel comprising two openings on said opposite portions of said side area for insertion of the vegetation cutting line, said at least one channel comprising two opposite first segments starting from said two openings towards an inside of the central body, and a curved connection segment between said first segments having a concave shape with a concavity upwards, said central body defining, in said concavity, a cavity comprising a bottom, said bottom being at a lower axial height than an axial height of said two openings, wherein said curved connection segment comprises a lower surface that is substantially continuous all along an extension thereof so as to be substantially closed downwards, with respect to an outer environment, to allow a single passage of the cutting line from one of said two openings towards another one of said openings without the vegetation cutting line exiting from said central body, said one of said two openings being opposite said another one of said two openings, said housing comprising side walls, said side walls having at least two opposite through holes for insertion of said vegetation cutting line suitable to be inserted in said at least one channel of said spool.
